(19) United States
(12) Patent Application Publication
(10) Pub. No.: US 2002/0133367 A1
(43) Pub. Date: Sep. 19, 2002

(54) Select-call administration system

(75) Inventors: Hideaki Miyazaki, Kawasaki (JP); Masanobu Morinaga, Kawasaki (JP); Noriyuki Fukuyama, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/911,476

(22) Filed: Jul. 25, 2001

(30) Foreign Application Priority Data
Mar. 16, 2001 (JP) 2001-075581

(51) Int. Cl. G06F 17/60

(52) U.S. Cl. 705/1

(57) ABSTRACT

Select-call administration system for efficiently administrating phone calls to reduce ineffectualness on the part of both calling and receiving parties when companies conduct sales and surveys. A voice announcement device 12 notifies a receiving terminal that a call from a calling terminal is a select phone call. A point-carrying phone call administration device 11 acquires correspondence information based on receiving-terminal correspondence to a call from a calling terminal. The system creates point information based on correspondence information acquired by the point-carrying phone call administration device 11, and presents awards such as discounts in call charges or exchange merchandise.

### BACKGROUND OF THE INVENTION

1. Technical Field

The present invention relates to a select-call administration system. More particularly, it relates to a select-call administration system that administrates calls pertaining to select phone calls between calling terminals and receiving terminals.

2. Description of Related Art

Because with standard telephone communications what a phone call is about cannot be confirmed on the receiving-terminal end before the fact, finding out the content has to be by conversing after the connection has been made. Consequently, when there is an incoming sales-call from a business on the telephone, this cannot be recognized at the receiving terminal, and therefore a connection is made for the time being. Telephone calls thus for sales, however, are often turned down by the receiving party before the main subject is talked about, rendering ineffectual the phone call once having been made. And because placing telephone calls voluntarily on the customer's part to answer business surveys is rare, getting effective responses is difficult.

As shown in published Japanese Laid-Open No. 10-145423, a point-adding system in e-mail is set forth as a system for promoting sales and surveys. With this system direct-mail e-mail is broadcast to users, and the users responding to the e-mail gives them points. If this sort of system were applied to telephony, the following problems would arise.

1) That mail is point-carrying can be determined from the subject line with e-mail, but cannot be realized with telephony.

2) In the case of e-mail, even after a message is downloaded it can be ignored and not read, but in the case of telephony once a call has been answered it cannot be ignored.

3) In the case of e-mail, that content has been conveyed to the user is understood by analyzing reply mail, but in the case of telephony, there is the hazard that content will go in one ear and out the other.

Special presents are moreover held in which points arising from phone calls are given to a third party apart from the calling party/receiving party. For example, by a party who wants to support fund-raising efforts for a select organization, such as UNICEF, placing a telephone call to a designated phone number, an information provision fee is billed to the calling party, with a portion passed on to the fund-raising.

In this case, it is only hoped that interested parties will voluntarily place telephone calls to designated phone numbers; and despite trying actively to present information, there is the risk of the foregoing problem, of being cut off before the main theme is talked about.

These sorts of problems can also arise with Internet telephony utilizing Internet circuitry, and phone call administration that is efficient both for calling and receiving parties is desirable.

### SUMMARY OF THE INVENTION

An object of the present invention is efficiently administrating calls to reduce ineffectualness on the part of both calling and receiving parties when companies conduct sales promotions, opinion surveys or the like.

The select-call administration system according to the present invention is a select-call administration system administrating a phone call concerning a select phone call between a calling terminal and a receiving terminal, comprising: select-call notification means for notifying the receiving terminal that a phone call from the calling terminal is a select phone call; correspondence information acquisition means for acquiring correspondence information based on correspondence of the receiving terminal to a phone call from the calling terminal; and point-award presentation means for generating point information based on correspondence information acquired by the correspondence information acquisition means and presenting awards based on the point information.

The select-call notification means may be configured so that it displays calling terminal identification information on the receiving terminal.

The calling terminal identification information may be a telephone number that begins with a predetermined number established for select calls.

The select-call notification means may also be configured so that it gives a voice message indicating that a phone call from a calling terminal is a select phone call, and it may be configured so that it includes in the transmission signal and transmits message information, to the effect that a phone call from a calling terminal is a select phone call.

The point-award presentation means may be configured so that it adds predetermined points based on correspondence information to a point value set at a receiving terminal that has received a phone call concerning a select phone call. In such a case, a system may be configured to further include point information storage means for administrating a point value set at a receiving terminal.

The point-award presentation means may be configured so that it gives a discount on charges for the receiving terminal based on point information administrated by point information administration means.

The point-award presentation means may also be configured so that it includes a merchandise information table wherein point information and product information are corresponded with each other, and so that it prompts a receiving terminal to select a desired product from a merchandise information table.

In addition, point-award presentation means may also be configured so that it adds predetermined points based on correspondence information to a point value set for a third party other than a calling terminal or receiving terminal.

The point-award presentation means may also be configured so that based on point information it bills the calling terminal that has made a call pertaining to a select phone call.

Correspondence information may be the length of time for a select phone call, and it may be operational information relating to the operations at a receiving terminal.

The system may also be configured to further include a point information notification means for, when a select phone call has ended, notifying a calling terminal and a receiving terminal of point information generated based on a phone call concerning a select phone call.

The point information notification means may be configured to give notification of point information using a voice message, or to transmit character information causing the display of point information on a display device of a transmitted terminal and a receiving terminal.

The system may also be configured so that it further includes point information setting means setting beforehand points to be added to a point value of a receiving terminal when a select phone call has been conducted in response to a phone call from a calling terminal, point prior-notification means notifying a receiving terminal when there is a select phone call from a calling terminal, and reception selections means prompting a receiving terminal to select whether or not to conduct a phone call in response to a phone call from a calling terminal.

The point information setting means may be configured to accept points-to-be-issued information from a calling terminal.

The receive-call selection means may be configured to contain reception condition acceptance means for accepting receive-call conditions from a receiving terminal for permitting a select phone call at a receiving terminal and reception rejection means for disconnecting a phone call from a calling terminal after comparing points-to-be-issued information from a calling terminal with receive-call conditions.

A select-call administration method that administrates a phone call concerning a select phone call between a calling terminal and a receiving terminal comprises: a step for notifying the receiving terminal that a phone call from the calling terminal is a select phone call; a step for acquiring correspondence information based on correspondence of the receiving terminal to a phone call from the calling terminal; and a step for generating point information based on correspondence information acquired by the correspondence information acquisition step and presenting awards based on the point information.

The system may be configured to further include a step for notifying a calling terminal and a receiving terminal when a select phone call has ended of point information generated based on a phone call concerning a select phone call.

The system may also be configured so that it further includes a step for setting beforehand points to be added to a point value of a receiving terminal when a select phone call has been conducted in response to a phone call from a calling terminal, a step for notifying a receiving terminal of set point information when there is a phone call from a calling terminal, and a step for prompting a receiving terminal to select whether or not to conduct a phone call in response to a phone call from a calling terminal.

Additionally, the system may be configured to further include a step for accepting from a receiving terminal receive-call conditions for permitting a select phone call, and a step for comparing point information sent from a calling terminal with receive-call conditions, and disconnecting a phone call from a calling terminal.

A program relating to the present invention is a computer-executable program for a select-call administration method that administrates calls concerning a select phone call between a calling terminal and a receiving terminal, said method comprising a step for notifying a receiving terminal that a phone call from a calling terminal is a select phone call, a step for acquiring correspondence information based on correspondence of a receiving terminal with a phone call from a calling terminal, and a step for generating point information based on correspondence information acquired by correspondence information acquisition means and for presenting awards based on point information.

In addition, the present invention presents a computer-executable program for a select-call administration method that administrates calls concerning a select phone call between a calling terminal and a receiving terminal, said method comprising a step for notifying a receiving terminal that a phone call from a calling terminal is a select phone call, a step for acquiring correspondence information based on correspondence of a receiving terminal with a phone call from a calling terminal, a step for generating point information based on correspondence information acquired by correspondence information acquisition means and for presenting awards based on point information, and a step for notifying a calling terminal and a receiving terminal, when a select phone call has ended, of point information generated based on a phone call relating to the select phone call.

The present invention also presents a computer-executable program for a select-call administration method that administrates calls concerning a select phone call between a calling terminal and a receiving terminal, said method comprising a step for setting beforehand point information to be generated when a select phone call has been held in response to a phone call from a calling terminal, a step for notifying a receiving terminal that a phone call from a calling terminal is a select phone call, a step for notifying a receiving terminal of set point information when a phone call from a calling terminal is received, a step for prompting a receiving terminal to select, in response to a phone call from a calling terminal, whether or not to hold a phone call, a step for acquiring correspondence information based on correspondence between a receiving terminal and a phone call from a calling terminal, and a step for generating point information based on correspondence information and presenting awards based on point information.

The present invention also presents a computer-executable program for a select-call administration method that administrates calls concerning a select phone call between a calling terminal and a receiving terminal, said method comprising a step for accepting from a receiving terminal receive-call conditions for permitting a select phone call at a receiving terminal, a step for setting beforehand point information to be generated when a select phone call has been held in response to a phone call from a calling terminal, a step for notifying a receiving terminal that a phone call from a calling terminal is a select phone call, and a step for comparing point information to be issued from a calling terminal with receive-call conditions and disconnecting the phone call from a calling terminal.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is a block diagram showing a configurational outline of a first embodiment;

FIG. 2 is a drawing for explaining an example of the service according to the present invention;

FIG. 3 is a diagram for explaining a point recording table;

FIG. 4 is a diagram for explaining a charge recording table;

FIG. 5 is a diagram for explaining a phone call length recording table;

FIG. 6 is a flowchart of the embodiment;

FIG. 7 is a diagram showing the sequence of events in point redemption processing;

FIG. 8 is a diagram for explaining a first guidance display screen;

FIG. 9 is a diagram for explaining a second guidance display screen;

FIG. 10 is a diagram for explaining a second guidance display screen;

FIG. 11 is a diagram for explaining a merchandise information table;

FIG. 12 is a block diagram of another embodiment;

FIG. 13 is a diagram for explaining a password table;

FIG. 14 is a diagram showing the sequence of events in point redemption using a web server;

FIG. 15 is a diagram for explaining a point redemption initial screen;

FIG. 16 is a diagram for explaining a production selection screen; and

FIG. 17 is a diagram for explaining a discount acceptance screen.

### DETAILED DESCRIPTION OF THE PREFERRED EMBODIMENTS

System Configuration

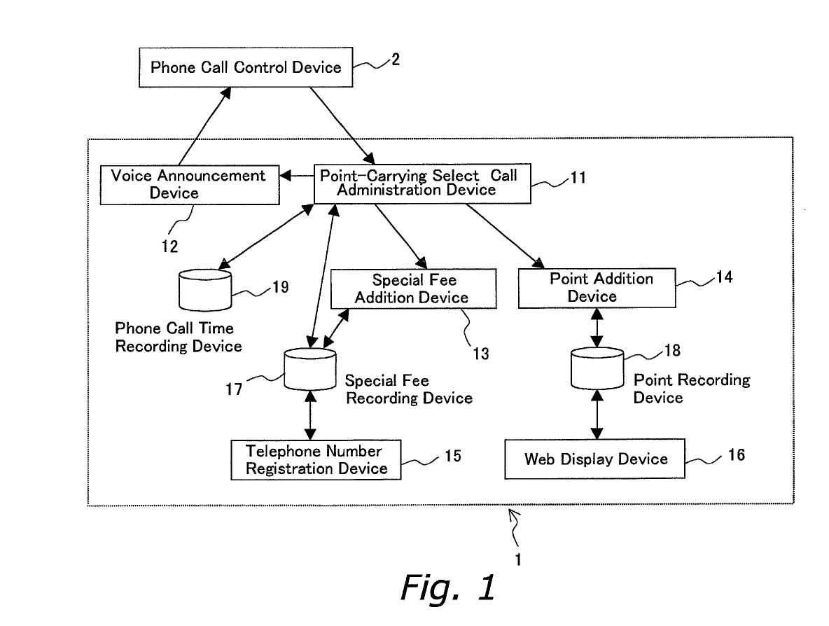

FIG. 1 is a block diagram showing an outline of a select-call administration system used in a first embodiment of the present invention.

A select-call administration device 1 is interconnected with a phone call control device 2 that administrates and controls calls. The phone call control device 2 may be a telephone switchboard or a device controlling a telephone switchboard (e.g., a gatekeeper for H.323 Internet telephony) at a telecommunications provider or Internet telephony service provider (ITSP) having a standard telephone network.

The select-call administration device 1 comprises a point-carrying select-call administration device 11 that controls and administrates point-carrying select calls, a voice-announcement device 12 that gives notification through a voice message, a special fee addition device 13 that adds special fees, a point addition device 14 that adds points, a telephone number registration device 15 that registers telephone numbers that make point-carrying telephone calls, a web display device 16 for checking points on the web, a special fee recording device 17 that records special fees charged for a point-carrying phone call, a point recording device 18 that records the number of points obtained through a point-carrying phone call, and a phone call time recording device 19 recording the length, etc., of a point-carrying phone call.

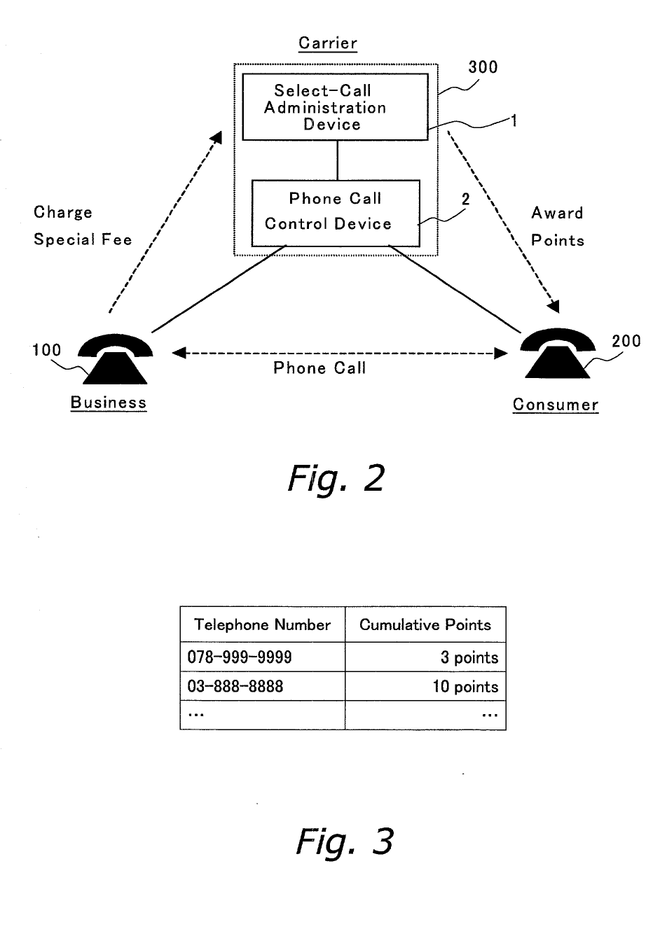

FIG. 2 shows an example of service provided.

The select-call administration device 1 and the phone call control device 2 are disposed in a carrier 300 that has standard telephone network circuitry, and controls calling and administrates point-carrying calls. A calling terminal 100 that executes sales and surveys for businesses and the like uses the phone call control device 2 of the carrier 300 to request connection with a receiving terminal 200 of a consumer, user and the like, and to give notification that a phone call is a point-carrying phone call and to present such service.

The point recording device 18 stores a point recording table, as shown in FIG. 3. The items in this point recording table are phone numbers for terminals and number of points accumulated. As shown in FIG. 2, with this service, when a point-carrying select phone call has been received by the receiving terminal 200 from the calling terminal 100, point information generated by the select phone call is added to the accumulated point value for the corresponding telephone number in the point recording table.

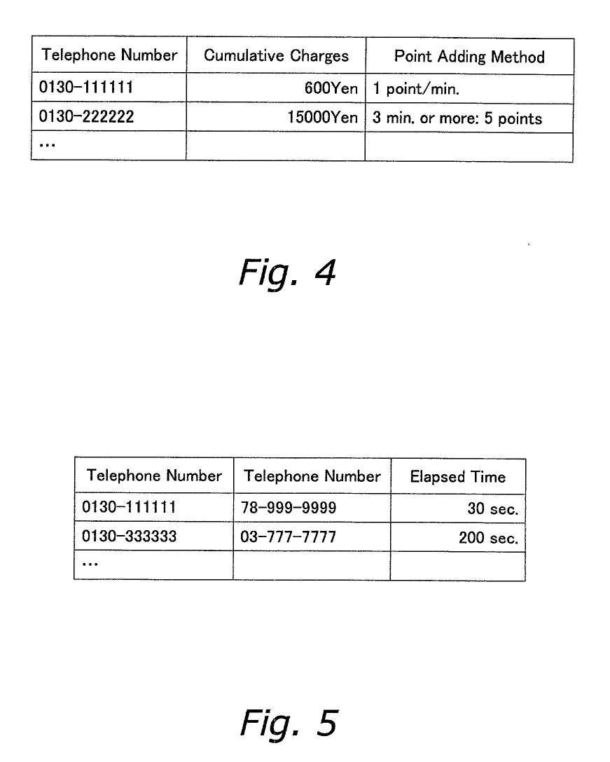

The special fee recording device 17 stores a fee recording table, as shown in FIG. 4. The items in this fee recording table are registered telephone numbers from businesses and the like that carry out select calls, accumulated fees, point addition methods and the like. Registered phone numbers may be phone numbers that begin with predetermined numbers to show that a phone call is a point-carrying phone call, for example, numbers beginning with “0130”. Also, the method for adding points to the receiving terminal 200 based on that phone call may be registered under point addition method.

The phone call recording device 19 stores a phone call time recording table, as shown in FIG. 5. This phone call time recording table has items for telephone number of calling terminal, telephone number of receiving terminal, and elapsed time. Conversation length of a point-carrying phone call is recorded for each phone call.

Usage Example

A business that wishes to conduct a point-carrying select phone call registers at the select-call administration device 1 the telephone number of a calling terminal that is to make that select phone call. For example, a telephone number beginning with a select number such as “0130” is registered at the select-call administration device 1. When notification of identifying information of a calling terminal is made using a caller ID service that causes the telephone number of a calling terminal to be displayed at a display device of a receiving terminal, notification that a phone call is a select phone call can be made easily, by setting beforehand telephone numbers that begin with such a select number; this also makes it easy for a user at a receiving terminal to recognize that a phone call is a select phone call. A telephone number for a calling terminal may also be a standard telephone number.

The select-call administration device 1 registers, via the telephone number registration device 15, a telephone number of a calling terminal in the fee recording table in the special fee recording device 17. At this time, a business may register as a point addition method the points to be awarded to a receiving terminal for a select phone call. For example, point addition rules such as “Add 1 point for each 1 minute of a select phone call” or “Add 5 points for a phone call 3 minutes or longer” are set. Set telephone numbers and point addition methods make up the fee recording table, as shown in FIG. 4.

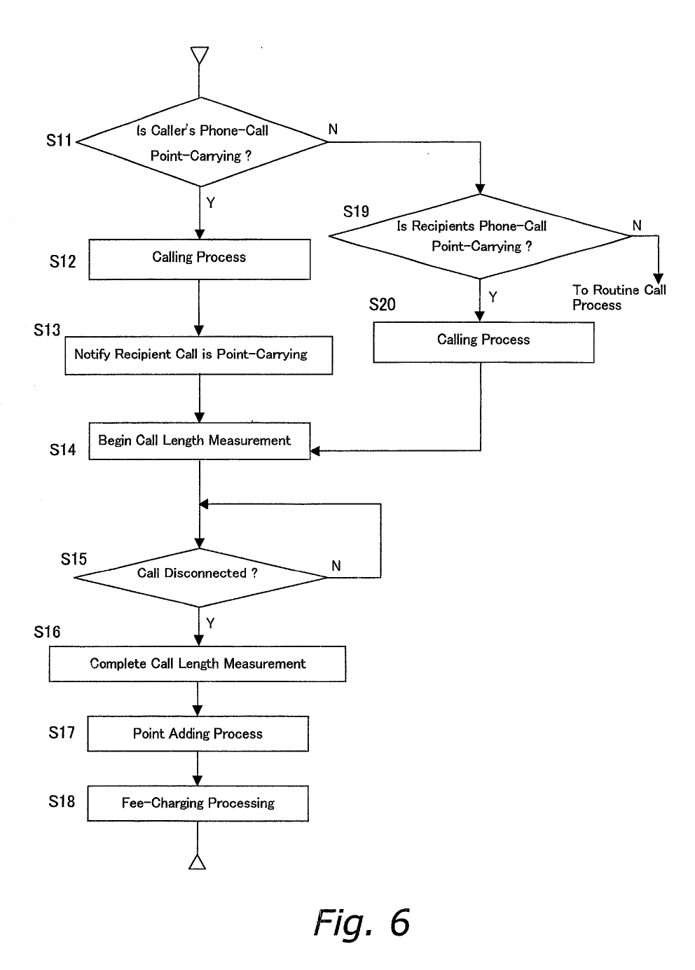

An explanation will be made based on the flowchart of FIG. 6 of a case where a point-carrying phone call, such as a sales phone call or survey, is made by a business to a customer.

In Step S11, it is determined whether a transmission from the calling terminal 100 is a point-carrying phone call or not. If the telephone number of the calling terminal 100 is a telephone number registered in the fee recording table, or is a telephone number beginning with a select number (“0130”), control proceeds to Step S12.

In Step S12, a phone call is made from the calling terminal 100 to the receiving terminal 200. Here the phone call can be made by transmitting phone call instructions to a telephone switchboard (or a device controlling a switchboard) that is the phone call control device 2.

In Step S13, notification is made to the receiving terminal 200 that a phone call is a point-carrying phone call. For example, the system may be configured so that, if a voice guidance device 12 is provided, when a connection is made with the receiving terminal 200, a voice message is transmitted from the voice guidance device 12 that explains to the receiving terminal 200 that a phone call is a select phone call. Alternatively, using a caller ID service, the display device of the receiving terminal 200 is caused to display the telephone number beginning with “0130” of the calling terminal 100 as well as the fact that a phone call is a point-carrying phone call. A configuration is also possible such that, when Internet telephony is used, the fact that a phone call is a point-carrying phone call and information of the points to be added because of the phone call are transmitted as character information and displayed at the display device of the receiving terminal 200.

When a phone call is begun at the receiving terminal 200, measurement of phone call time commences in Step S14.

In Step S15, it is determined whether the phone call has been terminated or not. If the connection has been terminated by either the calling terminal 100 or the receiving terminal 200, control proceeds to Step S16.

In Step S16, measurement of phone call time is ended, and the elapsed time is stored, along with the telephone number of the calling terminal and the telephone number of the receiving terminal, in an elapsed time column of the phone call time recording table (FIG. 5).

In Step S17, point addition processing is executed. Using the phone call time stored in the elapsed time column of the phone call time recording table and the addition method set in the item point addition method of the fee recording table at the calling terminal 100 (FIG. 4), point information for the receiving terminal 200 is created. The created point information is added to the corresponding receiving terminal accumulated point entry in the point recording table (FIG. 3), and the table is updated.

In Step S18, fee processing is executed. In this fee processing, a fee is computed for this select phone call using a predetermined method, and this fee is added to the accumulated fee for the calling terminal 100. For example, when a fee amount per 1 minute has been set for the elapsed time of a point-carrying phone call, the fee amount for this phone call is computed using the elapsed time of the conversation time recording table and the fee amount per 1 minute, and the entry for accumulated fees in the fee recording table is updated. If in addition a fee amount per 1 phone call is set, this predetermined amount is added to the accumulated fees for the calling terminal 100 and the data is updated.

If in Step S11 it is determined that a transmission from the calling terminal 100 is not a point-carrying phone call, control proceeds to Step S19. In Step S19, it is determined whether a phone call at the receiving terminal 200 is point-carrying or not. When transmission is made to a select telephone number and a phone call is held, there may be cases where the phone call causes point information to be generated and points awarded to the calling terminal 100, the receiving terminal 200, or to a third party. If it is determined that the receiving terminal 200 is such a select telephone number, control proceeds to Step S20; if not, then the standard phone call processing is executed.

An example of a case where points are awarded to a third party is when a select telephone number is a telephone number for accepting donations. In such a case, points calculated in Step S17 are recorded in the transmitting party's point recording table as points to be assigned to a third party, and a user cannot use these points. Alternatively, assigned points are recorded with the telephone number of the assignor in the point recording table entry corresponding to the select telephone number. For each carrier, donations are transferred to an account for the select telephone number according to the number of points assigned.

In this example, all the points were assigned for donations, but it is possible to have only a portion of the points arising from a phone call with a select telephone number or a phone call originating from a specified telephone number to be assigned for donation.

In Step S20, instructions for calling are transmitted to a telephone switchboard (or a device controlling a switchboard) that is the phone call control device 2, and a phone call is made from the calling terminal 100 to the receiving terminal 200. When a phone call is commenced at the receiving terminal 200 control moves to Step S14.

Actions & Effects

With this type of embodiment, because notification is made beforehand that a phone call to the receiving terminal 200 is a point-carrying phone call, it becomes easy for the user at the receiving terminal 200 to decide how to respond, and calls that would be a waste of time can be avoided. Thus for both the receiving terminal 200 and the calling terminal 100, there is increased efficiency. And because point information is added to the receiving terminal 200, there are more chances to have sales promotions from the calling terminal 100 listened to and surveys from the calling terminal 100 responded to, promoting an increase in advertising efficiency.

Variations

(A) The system may be configured so that simple questions concerning a select phone call from the calling terminal 100 are asked, and a user at the receiving terminal 200 is prompted to reply by pressing on buttons to make input. In such a case, the system is configured so that it is determined whether the inputted replies from the receiving terminal 200 are correct or not, and this is added to point information; in this way, it can be confirmed whether a customer is listening to the sales promotion, leading to greater certainty over whether the contents of a phone call have been properly conveyed.

(B) A configuration is possible such that when a phone call has ended, the point information arising from that phone call is computed and relayed to both the calling terminal 100 and the receiving terminal 200. For example, a voice message may give notification to the effect of, “The number of points arising from this phone call is 5,” or data may be transmitted to cause the display device of each terminal to display the number of points.

Point Redemption Method

A configuration is possible so that a user who has acquired at least a predetermined number of points is able to exchange those points for an article or receive a discount in charges for telephone services. An explanation will now be given of point-carrying phone call redemption methods.

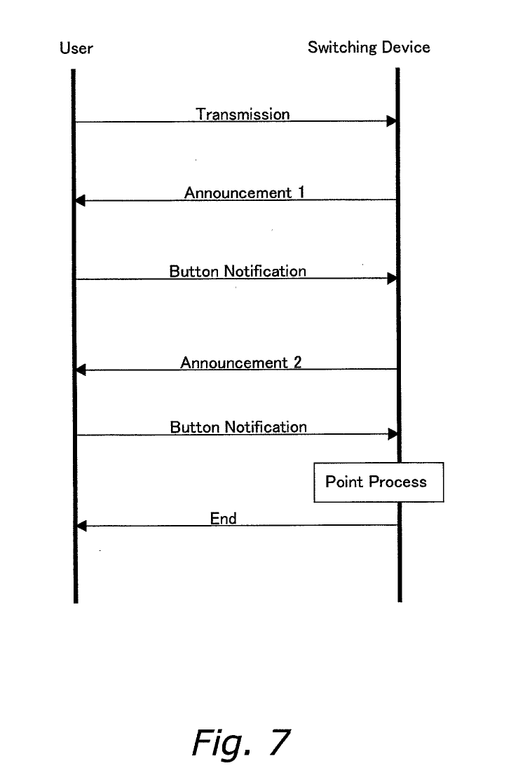

FIG. 7 shows the sequence of events during redemption of points for a user.

A user makes a transmission to a select telephone number and connects with a switchboard with which the select-call administration device 1 is connected. For example, the system is set so that calling a select telephone number such as “841” results in a connection with a switchboard having a select-call administration device 1. By making a transmission to this “841” number a user connects with a select switchboard.

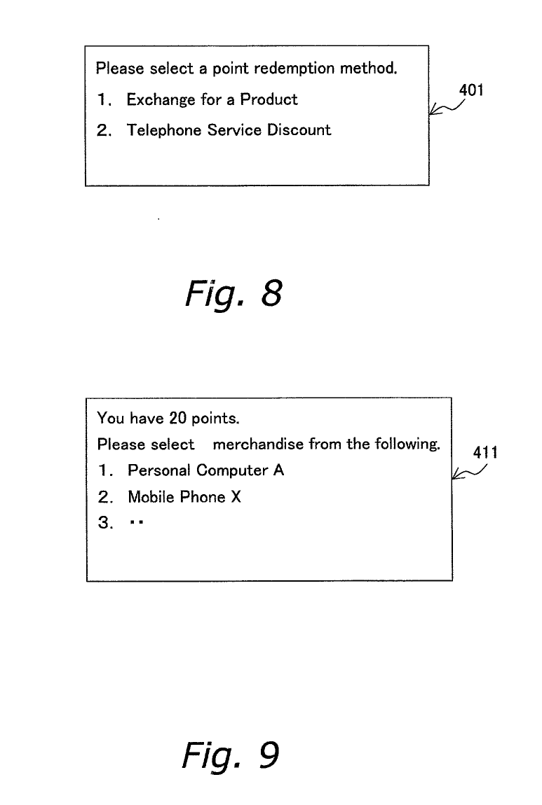

The select-call administration device 1 provided at a switchboard performs a first guidance display to prompt a user to select a point redemption method. For example, a first guidance display screen 401, as shown in FIG. 8, is displayed at a user's handset or the like. The first guidance display screen 401 displays the message, “please select a point redemption method,” as well as options for point redemption methods, such as “1: Exchange for a product” and “2: Telephone service discount.” In place of such displays, voice messages may be used.

A user selects an option as displayed by the first guidance display screen 401 or an option notified by a voice message, and by pressing on buttons on the terminal enters a selection for a point redemption method. For example, when a user wishes to exchange the points for a product, a user can give such notification by pressing the “1” button on his or her terminal; when a user wishes to receive a discount on services, a user can give such notification by pressing the “2” button on his or her terminal.

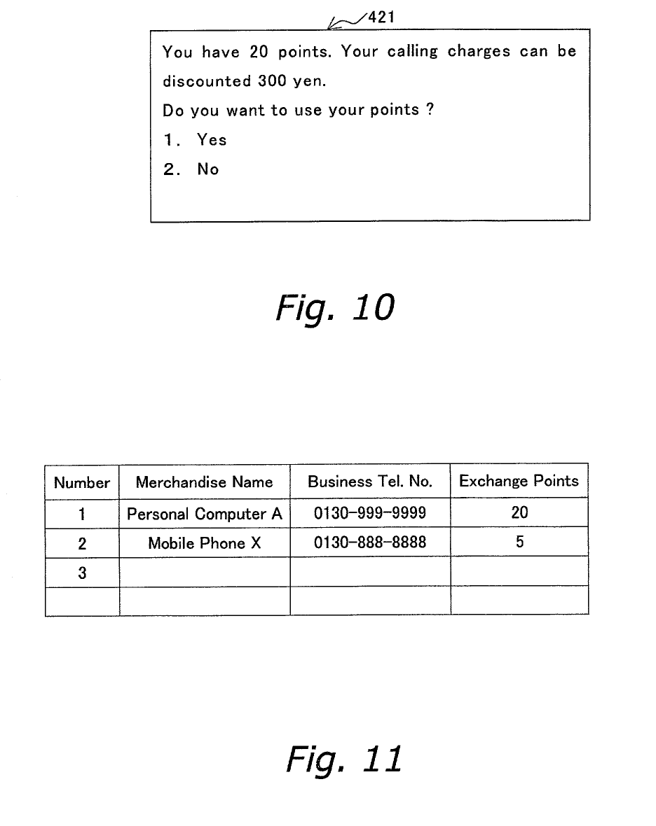

The select-call administration device 1, based on the selected item in the first guidance display, carries out a second guidance display positioned below that selected item. For example, it displays a second guidance display screen 411 as shown in FIG. 9 or a second guidance display screen 421 as shown in FIG. 10 on a user's handset or the like.

When “1: Exchange for a product” has been selected from the first guidance display screen 401, the second guidance display screen 411 is displayed, and the user's current point information is displayed as well as a list of products the user can receive in exchange for his or her current point value. The system may be configured so that, for example, a merchandise information table wherein point values and products are correlated is created beforehand as a database, and from this merchandise information table a list is displayed showing the products a user can receive in exchange for his or her current point value. For example, a system can be arranged so that a special fee is charged to a business presenting a product, and when a user desires to exchange points for a product, the price of that product is subtracted from that fee. In this case, a merchandise information table as shown in FIG. 11 is constructed, and from this merchandise information table products that a user can receive based on his or her current point information are displayed on the second guidance screen 411. A user can check on the second guidance display screen 411 a list of products that he or she can receive in exchange for his or her accumulated point total, and when a user selects a product from this second guidance display screen 411, he or she can give notification thereof by entering the product number by pressing the buttons with the corresponding numbers. So that an award is not made of a product with a price greater than the special fee charged to the business presenting the product, a product is displayed on the second guidance display screen 411 only when the following equation is satisfied: (business's special fee)—(the amount of money represented by the points needed to receive a product)>zero.

The second guidance display screen 421, which is displayed when “2: Telephone Service Discount” is selected from the first guidance display screen 401, displays a user's current point information as well as the discount amount, as well as the choice of whether or not to accept the discount in telephone service charges. If the user is to use the points, then he or she pushes the “1” button on the handset; if the user is not going to use the points, then he or she presses the “2” button on the terminal.

A configuration is possible such that for the second guidance display, too, a voice message is used in place of a display of this sort on a terminal display device, and to ask using a voice message whether or not an exchange of points for a product or an exchange of points for a discount will be made.

When a user gives notification from the second guidance display, the select-call administration device 1 executes point processing based on this notification. When a user has selected to exchange the points for a product, the point value of the selected product is subtracted from the user's current point total, and the accumulated point total in the point recording table is updated. The price of the product is subtracted from the special fee charged to the business presenting the product.

When a user has selected a discount in telephone charges, the point value used for the telephone charge discount is subtracted from the user's current point total and the point recording table is updated. The telephone charge discount amount as determined by the points used is subtracted from the user's telephone charges recorded in the switchboard, and this figure is updated.

Thereafter, the user is notified that point processing has been executed, the connection is cut and completion processing is conducted.

In this manner, because the system is configured so that a user can choose how to use his or her accumulated points, a user can choose a product that he or she likes, and if there is no such product, then a user can use the points to receive a discount in telephone charges.

Point Information Web Site

opening a web site relating to point information on the Internet allows a user to check point information and to choose how to use points over the Internet.

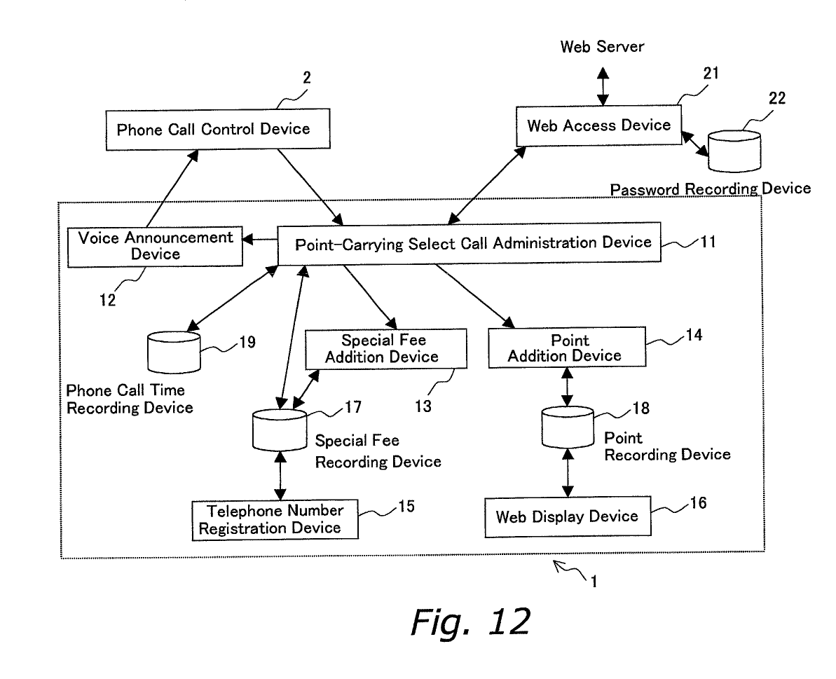

FIG. 12 is a block diagram showing an outline of the configuration used in such a case.

The configuration of the select-call administration device 1 and the phone call control device 2 are as described earlier, and a detailed explanation thereof will not be repeated. A point-carrying select call administration device 11 of the select-call administration device 1 is interconnected with a web access device 21. The web access device 21 connects a web server on the Internet with the select-call administration device 1; it is configured in such a manner that when a user accesses a select URL on the Internet, point information and the like within the select-call administration device 1 is used to provide the service of point redemption to the user.

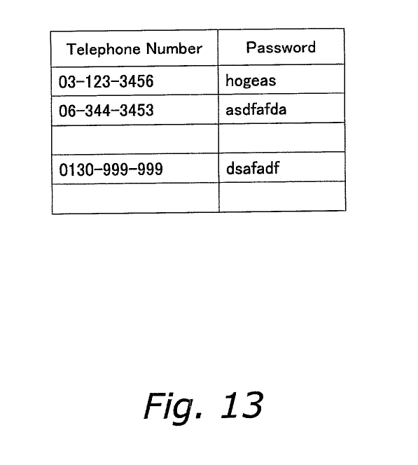

The web access device 21 contains a password recording device 22 that stores a password database. The password recording device 22 is provided with a password table as shown in FIG. 13. This password table contains entries for users' telephone numbers and passwords established by the users corresponding to those telephone numbers. Not only users, but businesses, too, establish passwords, and businesses too can manipulate the points.

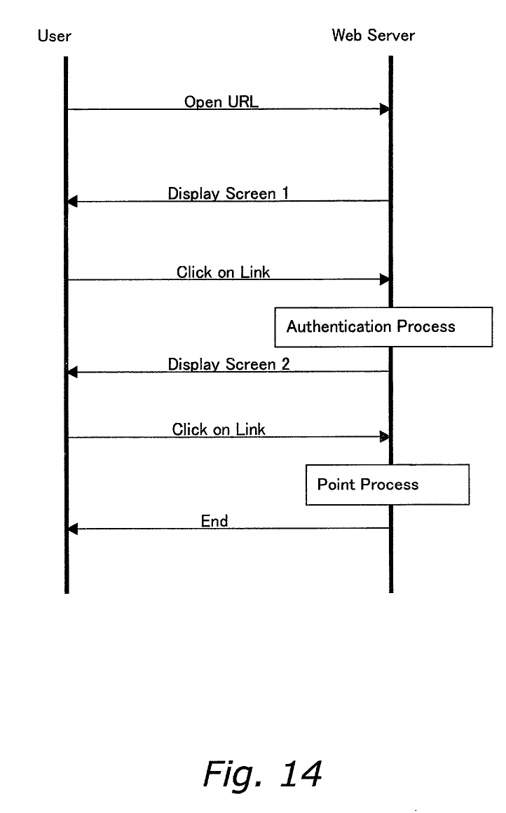

FIG. 14 shows the sequence of events when a user redeems points.

A user first accesses the web server on the Internet and opens a select URL. This select URL is a web site for point redemption, and available thereupon is a menu for point redemption processing. For example, a point redemption initial page 431 is displayed, as shown in FIG. 15. The point redemption initial page 431 contains a telephone number input field 432 and a password input field 433 and the like for user authentication, and further contains a product exchange button 434, a telephone charge discount button 435, and the like for selecting a point redemption method.

A user inputs his or her telephone number and password into the telephone number input field 432 and the password input field 433, respectively, of the point redemption initial page 431, and clicks on the point redemption method button of his or her choice.

The web server performs user authentication processing by comparing the telephone number and password transmitted by a user with the password table stored in the password recording device 22. If a user fails to be authenticated, the user is sent a display to that effect and error processing is carried out. If a user is authenticated, a second point redemption page is displayed, corresponding to the selected point redemption method.

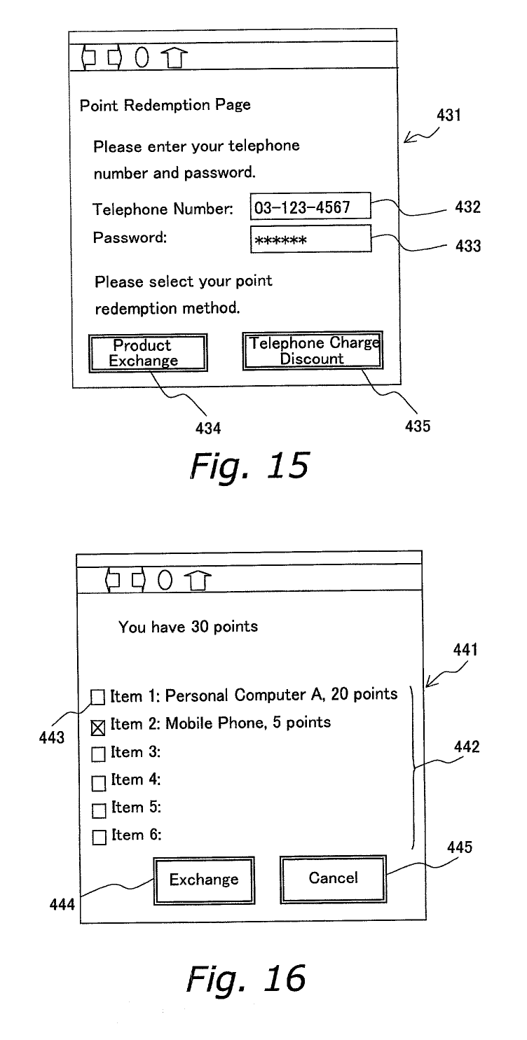

If the product exchange button 434 on the point redemption initial page 431 is clicked on, a product selection screen 441 as shown in FIG. 16 is displayed. The product selection screen 441 displays on a list display area 442 a user's current point information as well as a list of products that a user can receive in exchange for the points represented by that point information. On this list display area 442 is displayed product information selected in the same manner as described above from the merchandise information table. A checkbox 443 is displayed near each product displayed on the list display area 442; by clicking on a checkbox, a user desiring to exchange points for a product can make a product selection. The product selection screen 441 is provided with an exchange button 444 for confirming the selection of a product selected on the list display area 442 and a cancel button 445 for canceling a selection and returning to the previous display screen.

When a user decides to select a product, he or she checks the products displayed on the list display area 442, clicks on a checkbox 443 next to a product, and clicks on the exchange button 444, thereby transmitting notification of the decided-upon product for exchange. The web server sends the transmitted product for exchange information to the point-carrying phone call administration device 11 of the select-call administration device 1. The select-call administration device 1 updates the point recording table for the relevant user, and updates data relating to the special fee of the business providing that product.

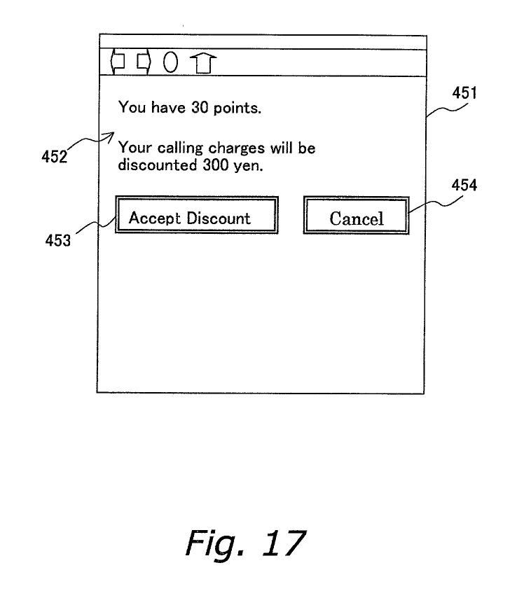

When the telephone charge discount button 435 on the point redemption initial page 431 is selected, a discount confirmation screen 451 as shown in FIG. 17 is displayed. This discount confirmation screen 451 has a discount information display area 452 displaying such information as a user's current point information and the amount of discount available based on that point information, a discount confirmation button 453 for consenting to the displayed discount, and a cancel button 454 for canceling the selection and returning to the previous display screen.

When a user wishes to receive a discount in telephone charges, he or she checks the information displayed on the discount information display area 452 and clicks on the discount confirmation button 453, thereby giving notification of consent to the discount. The web server sends the notification of consent to the discount to the point-carrying phone call administration device 11 of the select-call administration device 1. The select-call administration device 1 updates the point recording table for the relevant user, accesses a database administrating telephone charges and transmits the discount information.

Other Embodiments

A) Point information awarded to a user because of a select phone call can be linked with points of credit cards and the like, and can be made to function as electronic money useable on the Internet. For example, in Internet shopping, point information can be used to make purchases, or to receive a discount on a purchase.

B) In the embodiment described earlier, the receiving terminal 200 depends upon a telephone line, and a discount is given in the telephone charges paid to the communications business providing that line. A system can be configured so that when the receiving terminal 200 uses Internet telephony, a discount based on points is provided to the telecommunication charges paid to the business providing this service (i.e., the ITSP).

C) A system can be configured so that when a phone call for a select phone call originates from the calling terminal 100, notification is given beforehand of the point information to be added to the receiving terminal 200, and the user at the receiving terminal 200 is made to select whether or not to carry on the phone call. For example, a voice message explains, “This phone call is a select phone call, and 1 point will be added for each minute,” thus giving a user at the receiving terminal 200 a basis for deciding whether or not to carry on the phone call. A configuration is possible where, in place of a voice message, character information is displayed at a display device of the receiving terminal 200.

A configuration is also possible such that the user of the receiving terminal 200 is allowed to set beforehand predetermined point conditions, and only calls for select calls meeting or surpassing these point conditions are made, and calls that do not meet these conditions are automatically disconnected. For example, let us suppose that the user of the receiving terminal 200 has set the condition of “at least x points for 1 minute.” This information is administrated by the select-call administration device 1. When a phone call concerning a select phone call is made from the calling terminal 100 to the receiving terminal 200 under the condition “1 minute, y points,” if x is greater then y, the phone call is not made to the receiving terminal 200, and the line is disconnected. The system can be configured so that at this time the calling terminal 100 is notified that due to point conditions the phone call has been refused.

A user of the receiving terminal 200, by setting point conditions at the greatest possible value, can refuse all select calls such as sales calls. For example, by setting a point condition such as, “1 minute 9,999 points,” a user can refuse all select calls. Conversely, by setting point conditions at a minimum value, a user can make settings to receive all point-carrying calls, promoting an increase in accumulated points.

Through the use of the present invention, sales and opinion survey telephone calls made by businesses can be carried out with greater efficiency, and processing becomes more efficient for both a calling terminal and a receiving terminal. A user at a receiving terminal can redeem generated points for benefits, meaning that time spent on select calls is not fruitless. For a business this system means greater opportunities for marketing.

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. A select-call administration system administrating calls pertaining to select phone calls between calling terminals and receiving terminals, the select-call administration system comprising:
select-call notification means for notifying a receiving terminal that a call from a calling terminal is a select phone call;
correspondence information acquisition means for acquiring correspondence information based on receiving-terminal correspondence to a call from a calling terminal; and
point-award presentation means for creating point information based on correspondence information acquired by said correspondence information acquisition means and presenting awards based on said point information.

2. A select-call administration system according to claim 1, wherein said select-call notification means displays transmitting-terminal identification information on the receiving terminals.

3. A select-call administration system according to claim 1, wherein said transmitting-terminal identification information is a telephone number beginning with predetermined numerals established for said select phone call.

4. A select-call administration system according to claim 1, characterized by carrying out a voice announcement that a call from a calling terminal is a select call.

5. A select-call administration system according to claim 1, wherein said select-call notification means incorporates into a messaging signal and transmits message information to the effect that a call from a calling terminal is a select phone call.

6. A select-call administration system according to any of claims 1 through 5, wherein based on the correspondence information said point-award presentation means adds predetermined points to a point value set for a receiving terminal having received a call pertaining to a select phone call.

7. A select-call administration system according to claim 6, further comprising point information storage means for administrating point values set for the receiving terminals.

8. A select-call administration system according to claim 7, wherein based on point information administrated by said point information administration means said point-award presentation means discounts fees charged to the receiving terminals.

9. A select-call administration system according to claim 7, wherein said point-award presentation means:
is provided with a merchandise information table in which point information and product information are corresponded; and
prompts on the receiving terminals selection of desired merchandise from the merchandise information table.

10. A select-call administration system according to any of claims 1 through 5, wherein based on the correspondence information said point-award presentation means adds predetermined points to a point value set for a third party apart from the calling terminals and the receiving terminals.

11. A select-call administration system according to any of claims 1 through 10, wherein said point-award presentation means based on the point information charges fees to a calling terminal having transmitted a call pertaining to a select phone call.

12. A select-call administration system according to any of claims 1 through 11, wherein the correspondence information is call length of a select call.

13. A select-call administration system according to any of claims 1 through 12, wherein the correspondence information is operational information pertaining to operational content in the receiving terminals.

14. A select-call administration system according to either claim 12 or 13, further comprising point information notification means for reporting, to the calling terminal and the receiving terminal having completed a select phone call, point information created based on the call pertaining to the select call.

15. A select-call administration system according to claim 14, wherein said point information notification means reports the point information via voice announcement.

16. A select-call administration system according to claim 14, wherein said point information notification means transmits character information for displaying the point information on display devices on the calling terminals and the receiving terminals.

17. A select-call administration system according to any of claims 1 through 16, further comprising:
point information setting means for presetting points added to a point value for a receiving terminal when in response to a call from a calling terminal a select phone call has taken place;
point prior-notification means for notifying a receiving terminal, during issuance of a phone call from a calling terminal, of point information set by said point information setting means; and
receive-call selection means for a receiving terminal to select in response to a phone call from a calling terminal whether or not a select phone call takes place.

18. A select-call administration system according to claim 17, wherein said point information setting means accepts points-to-be-issued information issued from the calling terminals.

19. A select-call administration system according to claim 18, wherein said receive-call selection means is provided with:
receive-call condition acceptance means for accepting receive-call conditions from the receiving terminals to permit select calls on the receiving terminal end; and
receive-call rejection means for comparing with the receive-call conditions points-to-be-issued information issued from a calling terminal and disconnecting a call from the calling terminal.

20. A select-call administration method administrating calls pertaining to select phone calls between calling terminals and receiving terminals, the select-call administration method comprising:
a step of notifying a receiving terminal that a call from a calling terminal is a select phone call;
a step of acquiring correspondence information based on receiving-terminal correspondence to a call from a calling terminal; and
a step of creating point information based on correspondence information acquired by said correspondence information acquisition means and presenting awards based on said point information.

21. A select-call administration method according to claim 20, further comprising a step for reporting, to the calling terminal and the receiving terminal having completed a select phone call, point information created based on the call pertaining to the select call.

22. A select-call administration method according to claim 20, further comprising:
a step of presetting point information created when a select phone call has taken place in response to a call from a calling terminal;
a step of notifying a receiving terminal, during issuance of a call from a calling terminal, of the preset point information; and
a step of prompting a receiving terminal to select in response to a call from a calling terminal whether or not a phone call takes place.

23. A select-call administration method according to claim 20, comprising:
a step of accepting receive-call conditions from the receiving terminals to permit select calls on the receiving terminal end; and
a step of comparing with the receive-call conditions points-to-be-issued information issued from a calling terminal and disconnecting a call from the calling terminal.

24. A program for a select-call administration method administrating calls pertaining to select phone calls between calling terminals and receiving terminals, the program for executing on a computer the select-call administration method comprising:
a step of notifying a receiving terminal that a call from a calling terminal is a select phone call;
a step of acquiring correspondence information based on receiving-terminal correspondence to a call from a calling terminal; and
a step of creating point information based on correspondence information acquired by said correspondence information acquisition means and presenting awards based on said point information.

25. A program for a select-call administration method administrating calls pertaining to select phone calls between calling terminals and receiving terminals, the program for executing on a computer the select-call administration method comprising:
a step of notifying a receiving terminal that a call from a calling terminal is a select phone call;
a step of acquiring correspondence information based on receiving-terminal correspondence to a call from a calling terminal;
a step of creating point information based on correspondence information acquired by said correspondence information acquisition means and presenting awards based on said point information; and
a step of reporting, to the calling terminal and the receiving terminal having completed a select phone call, point information created based on the call pertaining to the select call.

26. A program for a select-call administration method administrating calls pertaining to select phone calls between calling terminals and receiving terminals, the program for executing on a computer the select-call administration method comprising:
a step of presetting point information created when a select phone call has taken place in response to a call from a calling terminal;
a step of notifying a receiving terminal that the call from the calling terminal is a select phone call;
a step of notifying the receiving terminal, during issuance of the call from the calling terminal, of the preset point information;
a step in response to the call from the calling terminal of prompting the receiving terminal to select whether or not the phone call takes place;
a step of acquiring correspondence information based on receiving-terminal correspondence to the call from the calling terminal; and
a step of creating point information based on correspondence information acquired by said correspondence information acquisition means and presenting awards based on said point information.

27. A program for a select-call administration method administrating calls pertaining to select phone calls between calling terminals and receiving terminals, the program for executing on a computer the select-call administration method comprising:
a step of accepting receive-call conditions from the receiving terminals to permit select calls on the receiving terminal end;
a step of presetting point information created when a select phone call has taken place in response to a call from a calling terminal;
a step of notifying a receiving terminal that a call from the calling terminal is a select phone call;
a step of comparing with the receive-call conditions points-to-be-issued information issued from the calling terminal and disconnecting the call from the calling terminal.
